(19) United States
(12) Patent Application Publication
(10) Pub. No.: US 2007/0242153 A1
(43) Pub. Date: Oct. 18, 2007

(54) Method and system for improving image region of interest contrast for object recognition

(76) Inventors: Bei Tang, Palatine, IL (US); Allyson J. Beuhler, Woodridge, IL (US); King F. Lee, Schaumburg, IL (US)

Correspondence Address: MOTOROLA, INC., 1303 EAST ALGONQUIN ROAD, IL01/3RD, SCHAUMBURG, IL, 60196, US

(21) Appl. No.: 11/402,518

(22) Filed: Apr. 12, 2006

(51) Int. Cl. H04N 5/238

(52) U.S. Cl. 348/365

(57) ABSTRACT

A method includes locating a region of interest in an image and measuring a contrast level of the region of interest. At least one sensor setting is adjusted to increase the contrast level of the region of interest to at least the predetermined threshold level in response to the contrast level being below a predetermined threshold level.

### CROSS-REFERENCE TO RELATED APPLICATIONS

The present application is related to the following U.S. application commonly owned together with this application by Motorola, Inc.:

Ser. No. 11/044,738, filed Jan. 26, 2005, titled “Object-of-Interest Image Capture” by Lee, et al. (attorney docket no. CML02197E).

### TECHNICAL FIELD

This invention relates generally to improving contrast in a region of an image for object recognition.

### BACKGROUND

Object recognition tasks such as license plate recognition usually need high contrast “region of interest” (“ROI”) images as inputs in order to achieve a high degree of confidence in localizing and recognizing an object of interest. Many cost-effective image capture systems utilize complimentary metal oxide semiconductor (“CMOS”) imagers with a miniature type of lens to acquire the source images for object recognition.

The default settings of such imagers are typically for general viewing purposes only. They are, however, not necessarily good for image recognition tasks. In many cases they do not provide good contrast in the ROI and result in poor object recognition in computer vision applications.

The level of contrast in an image can be adjusted based on a setting of the blackest intensity value in the image, i.e., the baseline black level. Systems in the art typically perform a black level calibration (“BLC”) by shielding certain light-sensing elements in an array of light-sensing elements and measuring the signal level across at least one of the so-called “black rows” and “black columns.” This default BLC method is fine for general viewing purposes for the entire image. For particular object recognition tasks, however, the default BLC method does not provide a good contrast in the ROI. That is, because the pixels values vary throughout the entire image, optimization of the contrast for the entire image frame typically fails to provide sufficient contrast in the ROI for some object recognition tasks. Object recognition tasks such as license plate recognition are therefore not as reliable as they could be because current systems do not sufficiently optimize the contrast within the ROI.

### BRIEF DESCRIPTION OF THE DRAWINGS

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the present invention.

FIG. 1 illustrates a camera acquiring images according to an embodiment of the invention;

FIG. 2 illustrates an image frame acquired by the camera according to an embodiment of the invention;

FIG. 3 illustrates a process of locating an ROI in an image frame according to an embodiment of the invention;

FIG. 4 illustrates a process of acquiring an image frame having optimal contrast in the ROI according to an embodiment of the invention;

FIG. 5 illustrates an image sensor system for adjusting the contrast level of image frames acquired according to an embodiment of the invention;

FIG. 6 illustrates an image of a license plate acquired according to the default settings of the image sensor;

FIG. 7 illustrates a subsequently acquired image after adjusting the analog BLC value according to an embodiment of the invention;

FIG. 8 illustrates a subsequently acquired image after adjusting the digital gain according to an embodiment of the invention;

FIG. 9 illustrates a plot of the contrast measurements of the ROI region of the images of FIGS. 6-7 according to an embodiment of the invention;

FIG. 10 illustrates a first image of an automobile that has been acquired with the default settings for BLC adjustment according to an embodiment of the invention;

FIG. 11 illustrates a second image of the automobile that has been acquired with adjusted BLC values designed to optimize the contrast of the ROI region of the image according to an embodiment of the invention;

FIG. 12 illustrates a third image of the automobile that has been acquired with the adjusted BLC values designed to optimize the ROI contrast and the adjustment of the digital gain setting according to an embodiment of the invention; and

FIG. 13 illustrates a plot of the contrast measurements of the ROI of the images of FIGS. 10 and 11 by adjusting BLC values according to an embodiment of the invention.

### DETAILED DESCRIPTION

Before describing in detail embodiments that are in accordance with the present invention, it should be observed that the embodiments reside primarily in combinations of method steps and apparatus components related to a method and apparatus for improving image region of interest contrast for object recognition. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein. Thus, it will be appreciated that for simplicity and clarity of illustration, common and well-understood elements that are useful or necessary in a commercially feasible embodiment may not be depicted in order to facilitate a less obstructed view of these various embodiments.

It will be appreciated that embodiments of the invention described herein may be comprised of one or more conventional processors and unique stored program instructions that control the one or more processors to implement, in conjunction with certain non-processor circuits, some, most, or all of the functions of the method and apparatus for improving image region of interest contrast for object recognition described herein. As such, these functions may be interpreted as steps of a method to perform the improving image region of interest contrast for object recognition described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

Generally speaking, pursuant to these various embodiments, a method, apparatus, and system are provided that improve the contrast for a particular “region of interest” (“ROI”) in an image. The image may be received from a video source for processing. The ROI may then be located within the image. For example, the image may be analyzed to detect an object of interest, such as a license plate in an image of an automobile or a road sign. If the object of interest is detected in the image, the ROI is obtained by, for example, bounding a box around the image of the license plate. Alternatively, the ROI may be determined based on prior knowledge of where the object of interest is likely to be located in the image.

The contrast level of the ROI is then measured and sensor settings are adjusted to achieve an optimal contrast in the ROI. The contrast level may be measured by, e.g., calculating the sum of the absolute differences between pixels in the ROI to determine whether it meets the object recognition requirements. If it does not, the sensor black level calibration value and/or other sensor settings are adjusted to increase the image's ROI contrast until it reaches an optimal contrast range. For example, because the pixel values vary throughout the entire image, a superior ROI contrast level may be achieved by intentionally adjusting sensor settings to optimize the contrast in the ROI as opposed to attempting to optimize the contrast of the entire image as has been done previously in the art.

Once the contrast level has been optimized, a new image is captured with the optimized sensor settings, and the new image may then be analyzed for the actual recognition process. Accordingly, as discussed above, by adjusting sensor settings to optimize the ROI contrast level, better ROI contrast may be achieved than would normally be possible if the contrast level of the entire image were optimized. As a result, superior object recognition may be achieved.

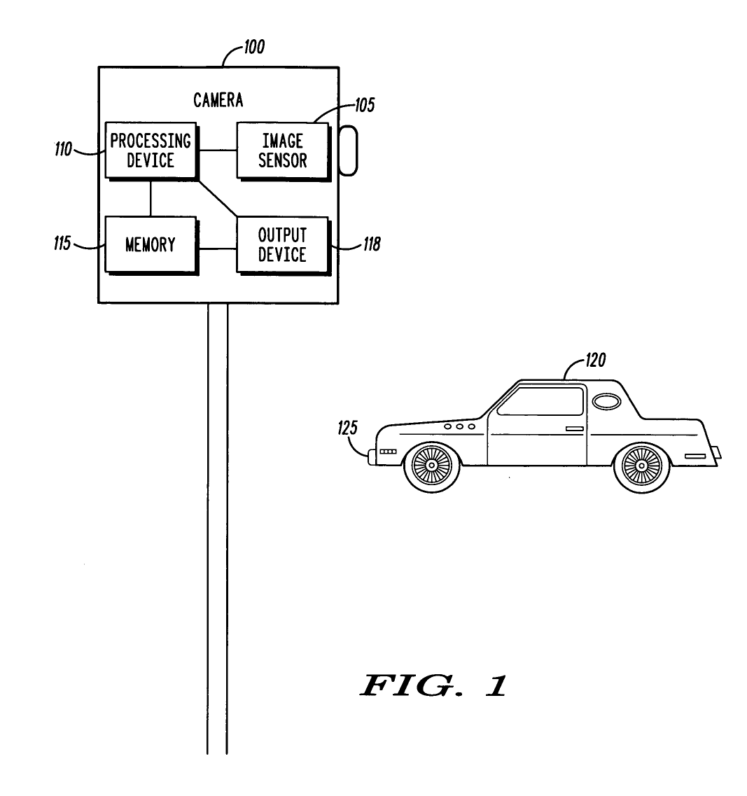

FIG. 1 illustrates a camera 100 acquiring images according to an embodiment of the invention. As shown, the camera 100 includes an image sensor 105 to capture an image, a processing device 110 to process the captured image, and a memory 115 to store both program code executable by the processing device 110 and a representation of the image. For example, the image may be stored as a Joint Photographic Experts Group (“JPEG”) image in the memory 115. The camera 100 may also include an output device 118 such as a modem to communicate the image and/or data with other camera, servers, or databases, or any other related device used for or related to the processing of images.

The camera 100 may acquire images of an automobile 120 or some other object such as a traffic sign. The automobile 120 may include a license plate 125, the numbers or other symbols on which may be determined by analyzing the images via an object/character recognition process implemented by the processing device 110 and/or an additional processing device contained within or outside of the camera 100. Accordingly, in an embodiment, the camera 100 may be utilized, e.g., to monitor automobile traffic through an intersection and determine the objects/characters on a license plate 125 of an automobile 120 speeding through a traffic signal. By acquiring the images and then analyzing the images to determine the objects/characters on the license plate, the identity of the automobile 120 may be automatically determined so that a citation may be sent to the owner of the automobile 120.

In the event that the camera 100 is used outside of an enclosed area, the lighting conditions may vary throughout the day. Accordingly, under some conditions the intensity of the light may be low relative to the intensity of the light during the afternoon on a sunny day, or too bright at some times relative to the normal lighting conditions. A certain amount of contrast in the images acquired by the camera 100 is required in order to be able to analyze the images and perform object/character recognition with a high degree of accuracy. Unfortunately, when the lighting conditions are significantly dark or bright, the image may have worse contrast than when the light conditions are relatively normal, making object/character recognition more difficult.

Accordingly, to improve the reliability of the object/character recognition, the contrast of a certain area of the image is improved. Specially, as discussed above, a particular region of interest (“ROI”) in an image is identified and then analyzed and processed to improve the contrast of the ROI in a subsequent image acquired by the camera 100.

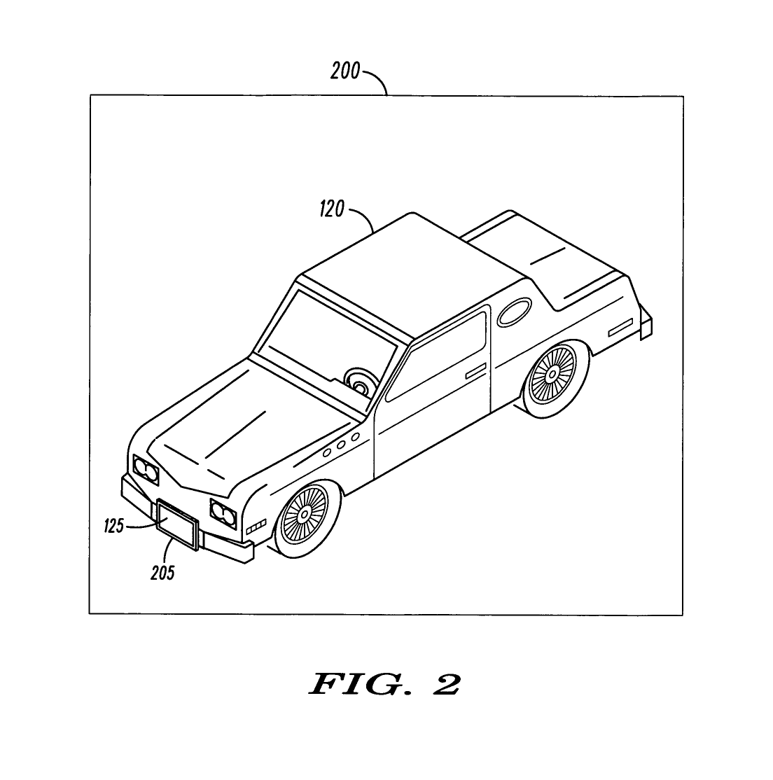

FIG. 2 illustrates an image frame 200 acquired by the camera 100 according to an embodiment of the invention. As shown, the image frame 200 has a representation of the automobile 120 and the license plate 125 of the automobile 120. When the image frame 200 is received by the processing device 110 of the camera 100, the image frame 200 is initially analyzed to determine the ROI. The ROI may be determined based on prior knowledge of where the ROI is likely to be, or it may located by processing all of the pixels in the image frame 200 to locate a particular object known to be located within the ROI based on the pixel characteristics of that object. For example, color or gray scale values of those pixels may be utilized to determine the recognized object. In the image frame 200 of FIG. 2, an ROI 205 is located and an analysis may subsequently occur.

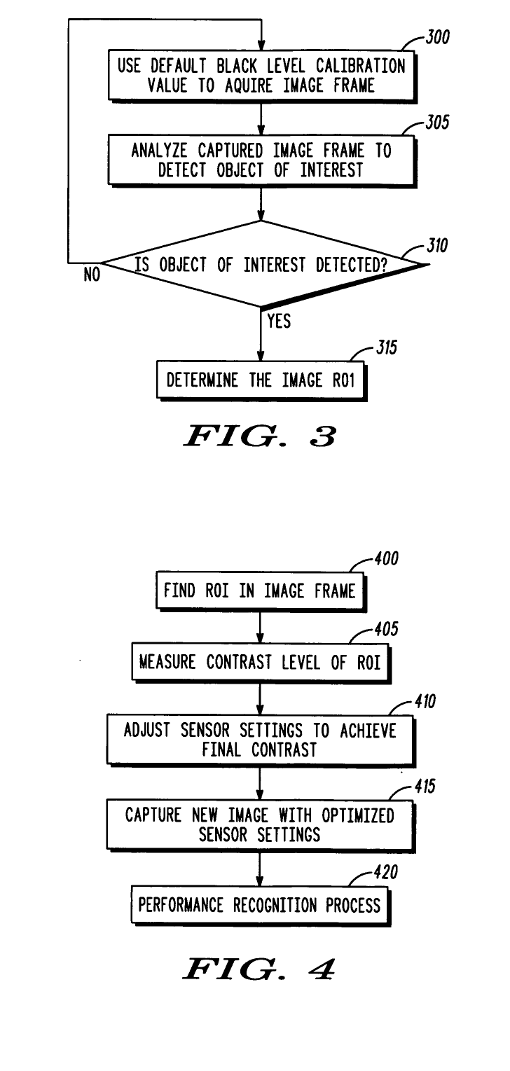

FIG. 3 illustrates a process of locating an ROI in an image frame 200 according to an embodiment of the invention. First, at operation 300, the default black level calibration value of the image sensor 105 is used to acquire the image frame 200. Specifically, the image sensor 105 may include default settings of the blackest measurable intensity level, i.e., a baseline black level. Next, at operation 305, the captured image frame 200 is analyzed to detect an object of interest, which may be, for instance, a predetermined object having alphanumeric symbols such as a license plate or a road sign. For example, if the object of interest is known to have a rectangular shape and have its edges formed of pixels having a bright intensity, the intensity values and locations of those values in the captured image frame 200 may be analyzed to determine whether the object of interest is located within the image frame 200. Next, at operation 310, the processing determines whether the object of interest is detected within the image frame 200. If it is not, processing returns to operation 300 and another image frame 200 is acquired. If it is detected, on the other hand, processing proceeds to operation 315 where the image ROI 205 is determined. The image ROI 205 may be comprised of a box of pixels surrounding, and including, the object of interest, as discussed above.

FIG. 4 illustrates a process of acquiring an image frame 200 having optimal contrast in the ROI 205 according to an embodiment of the invention. First, at operation 400 the ROI 205 of the image frame 200 is located. The ROI 205 may be located according to the process described above with respect to FIG. 3, or it may be determined based on prior knowledge of where the ROI 205 is likely to be in the image frame 200. Next, at operation 505, the contrast level of the pixels within the ROI 205 is measured. The contrast level of the ROI 205 may be measured, for instance, based on the “sum of absolute differences” between adjacent pixels in the ROI 205.

For example, if there are 1000 pixels within the ROI 205, and each pixel has a gray scale value representative of its intensity, the sum of the absolute differences will generally be large in a high contrast ROI 205 and low in a low-contrast ROI 205. In the event that the image frame 200 is acquired, e.g., on a bright day by the camera 100, there may be a larger difference between pixel intensities of adjacent pixels representative of a license plate 125 than would be present if the image frame 200 had been taken at night when the intensity values of the sky are much lower, i.e., closer to the black level baseline. The contrast level, C, of the ROI 205 may be calculated based on the following equation:
C=[1/(# of pixels in the ROI)]ΣᵢΣⱼ|P(i,j+1)−P(i,j)|,

For all i, j within the ROI 205, where i represents a pixel row number, j represents a pixel column number, and P represents a pixel intensity value.

Alternatively, any other suitable method of measuring image contrast may be utilized such as an ROI histogram-based measurement, because a histogram can be used to describe the amount of contrast. Contrast is a measure of the difference in brightness between light and dark areas in an image. Broad histograms reflect an image with significant contrast, whereas narrow histograms reflect less contrast and may appear flat or dull.

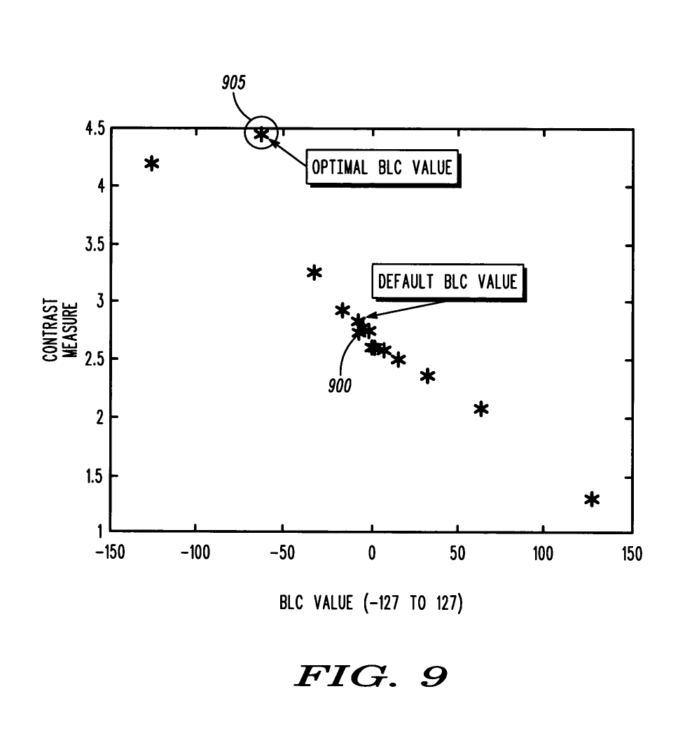

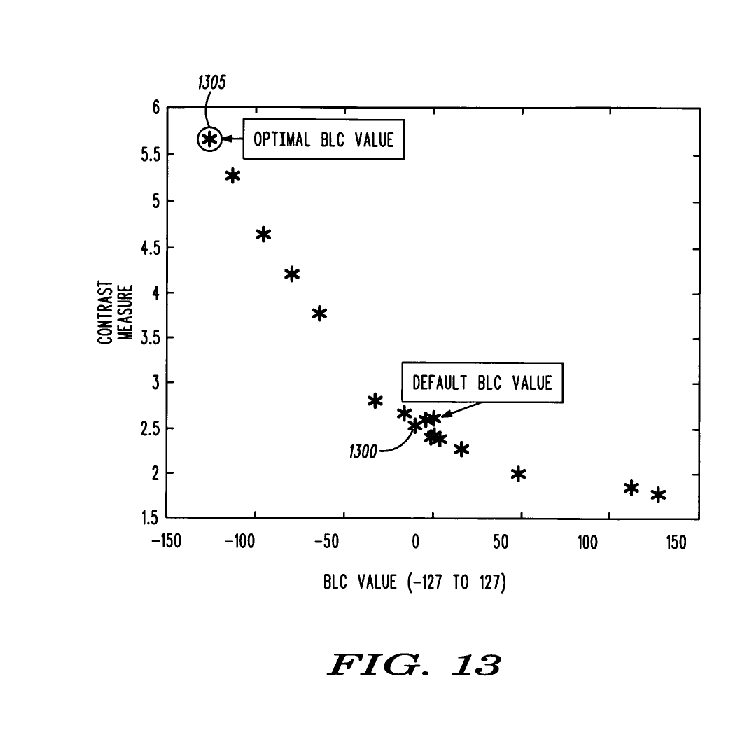

Referring back to FIG. 4, at operation 410, the sensor settings of the image sensor 105 are adjusted to achieve optimal contrast. Optimal contrast is achieved where the contrast level is at least a predetermined threshold level. For example, when measuring contrast using the absolute sum of differences as described above, optimal contrast is achieved when the sum (i.e., C) meets the predetermined threshold level. Depending on the application, the predetermined threshold level can be determined empirically. For example, in a license plate recognition application, this predetermined threshold level may be set at a certain value to allow the plate image to have good contrast so that the application requirements for plate reading accuracy are met or exceeded. In other words, the predetermined threshold level may be set at a level where most of license plates are correctly recognized and the final recognition accuracy is, e.g., exceeding 95% percent if that is the required accuracy for the license plate recognition system. In the particular case corresponding to the use of the sum of absolute differences as a contrast measure (i.e., the formula discussed above for determining C), an exemplary threshold level value can be set at a value of 4.0, which corresponds to the plots shown in FIGS. 9 and 13 discussed below.

Referring back to FIG. 4, processing subsequently proceeds to operation 415 where a new image frame 200 is captured with the optimized sensor settings. Finally, at operation 420, the image recognition process may be performed on the optimized image frame 200 to determine recognized objects or characters within the ROI 205.

FIG. 5 illustrates an image sensing system 500 for adjusting the contrast level of image frames 200 acquired according to an embodiment of the invention. The image sensing system 500 may be located, e.g., in an image sensor. Image sensor pixels 502 provide the active output voltage corresponding to light sensed by the image sensing system 500. A BLC value register 525 is utilized to set the value of an offset correction voltage. The offset correction voltage is provided that corresponds to the black level calibration (“BLC”) sensor setting generated based on the measurement of ROI contrast as discussed above with respect to FIG. 4. This offset correction voltage is the baseline black level. This offset correction voltage value is added to the pixel output, i.e., the measured pixel intensity value, for a pixel of the image sensor 105 at an addition element 505.

The sum of the pixel output and the offset correction voltage is multiplied by an analog gain selection value by a multiplication element 510. The analog gain selection value is configurable and may be systematically adjusted until an optimal contrast level is achieved in an image frame 200 acquired by the camera 100. The multiplied value is output to an analog-to-digital converter (“ADC”) 515 which converts the analog signal into a digital value. The digital value may be comprised of 10 bits of data, for example. The digital value is subsequently output to multiplier 520 which multiples the digital value by a digital gain value from digital gain registers. The digital gain value is configurable to increase the contrast level by an additional amount.

The addition element 505, multiplication element 510, ADC 515, and multiplier 520 may each be located inside of an image sensor and can be adjusted through programming image sensor registers. As discussed above, the offset voltage value corresponds to the baseline black level and is determined before analog to digital conversion by the ADC 515 takes place, so it is still an analog signal and the value can therefore be adjusted through programming the BLC value register 525. The BLC value register 525 may be programmed, e.g., manually be the user. As discussed above, different schemes are used to adjust the BLC value of the BLC value register 525 which change the offset voltage value of the image sensor system's 500 circuitry to improve image contrast.

On the analog side of this contrast optimization system (i.e., after the ADC 515), the gain may be increased by a certain amount. However, there is a limitation to how much gain may be added on the analog side. For example, adding too much gain on the analog side would increase the analog signal as well as the floor noise while reducing the signal-to-noise ratio which would not be advantageous for the image data. The digital gain is therefore also useful. Moreover, analog circuits have a maximum limitation in terms of gain and can only boost a signal by that much. In some environments such as a low-light environment, however, the gain would sufficiently boost the signal. The system shown in FIG. 5 may be contained within a single semiconductor chip. This chip may include a traditional sensor and color processing functionality on one chip to save power and space. To boost the digital gain, this System on a Chip solution, an image processor companion chip, or even software control, may be used to boost the image intensity.

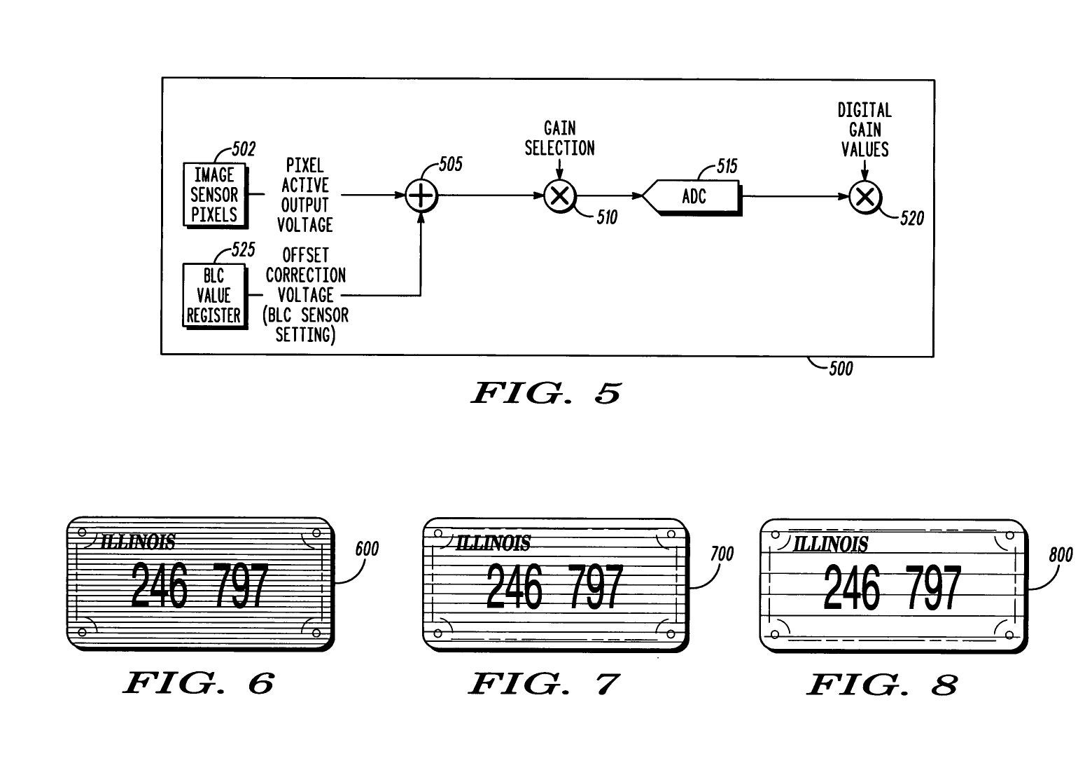

FIG. 6 illustrates an image 600 of a license plate acquired according to the default settings of the image sensor 105. In this case, the default BLC value is about −10 when the BLC has a maximum range between −127 and +127. Application of the sum of the absolute differences formula results in C being determined to be about 2.7809. A default digital gain of 1.0 is utilized in this case. As shown, the image 600 of the license plate is relatively dark and lacks good contrast.

FIG. 7 illustrates a subsequently acquired image 700 after adjusting the analog BLC value according to an embodiment of the invention. In this case, the ROI has been optimized by adjusting the BLC value to a value of −60, while leaving the digital gain unchanged at 1.0. After making these adjustments, application of the sum of the absolute differences formula results in C being determined to be about 4.50. As shown, the contrast of the image 700 of the license plate has been improved over where it was in FIG. 6, but the image 700 is still relatively dark. The analog gain, as discussed above, with respect to FIG. 5, is programmable through sensor registers.

FIG. 8 illustrates a subsequently acquired image 800 after adjusting the digital gain according to an embodiment of the invention. In this case, the same BLC value is used as was used to acquire the image 700 shown in FIG. 7, i.e., −60. The digital gain, however, has been set at 3.75. The resultant image 800 is much brighter than the images shown in FIGS. 6 and 7, and the numbers of the license plate image are more discernible. After making the adjustment to the digital gain, application of the sum of the absolute differences formula results in C being determined to be about 10.7104.

Accordingly, as shown by the differences in the images shown in FIGS. 6-8, optimizing the contrast of the ROI by adjusting the BLC value and the digital gain value can greatly improve the contrast of the resultant image, making object recognition easier and more reliable. Various optimization methodology for multiple variables may be used for adjusting the sensor setting values.

One possible optimization strategy as an example is to achieve the optimal setting for each register in serial fashion. For, example, the black level calibration value may first be adjusted to achieve optimal ROI contrast, and then the digital gain may be adjusted to further boost contrast in a subsequently acquired image.

FIG. 9 illustrates a plot of the contrast measurements of the ROI of the license plate images of FIGS. 6-7 according to an embodiment of the invention. As shown, at the default BLC value of about −10, the contrast level is about 2.7809 as shown with the first plot location 900. However, if the BLC is optimized to −60, the contrast level is maximized at a value of about 4.50, as shown with the second plot location 905. Therefore, as shown, the contrast level is a function of the BLC value and may be optimized to achieve the maximum contrast.

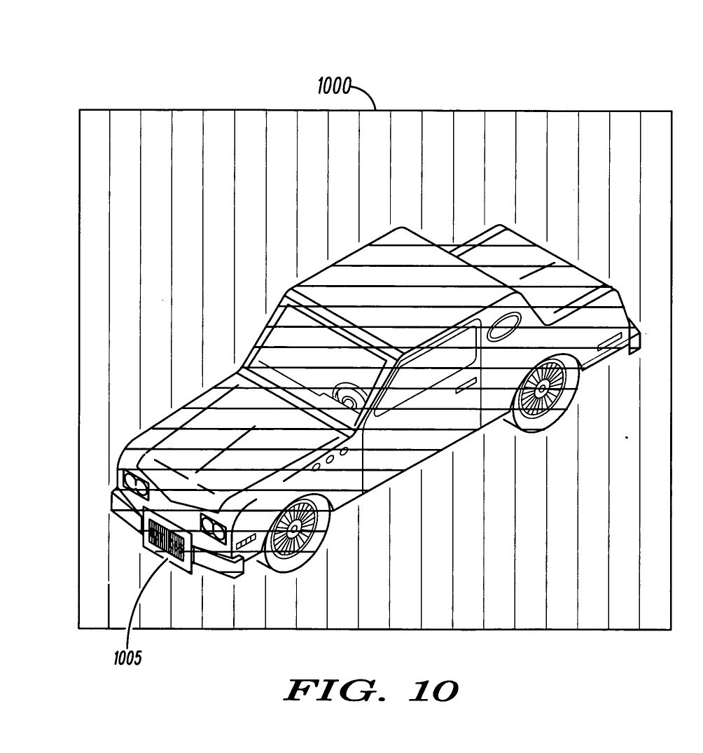

The normal value from default automatic BLC adjustment coming from the sensor is close to a value of 0. This is based on detection of black rows or columns by the sensor. Embodiments of the present invention, however, use the ROI contrast measurement, as discussed above to adjust the BLC value. Optimal BLC values are, frequently far away from the normal values of 0 and may be, e.g., −60 as discussed above with respect to FIG. 9. The optimal BLC values may be even more extreme in other examples, as discussed below with respect to FIGS. 10-13.

FIG. 10 illustrates a first image 1000 of an automobile that has been acquired with the default settings for BLC adjustment according to an embodiment of the invention. For example, the BLC value may be about −10. As shown, the contrast in the entire first image 1000 is good in that the automobile is clearly visible. The contrast in an ROI 1005 of the first image 1000, however, is relatively poor. Consequently, the numbers on the license plate within the ROI 1005 are difficult to identify.

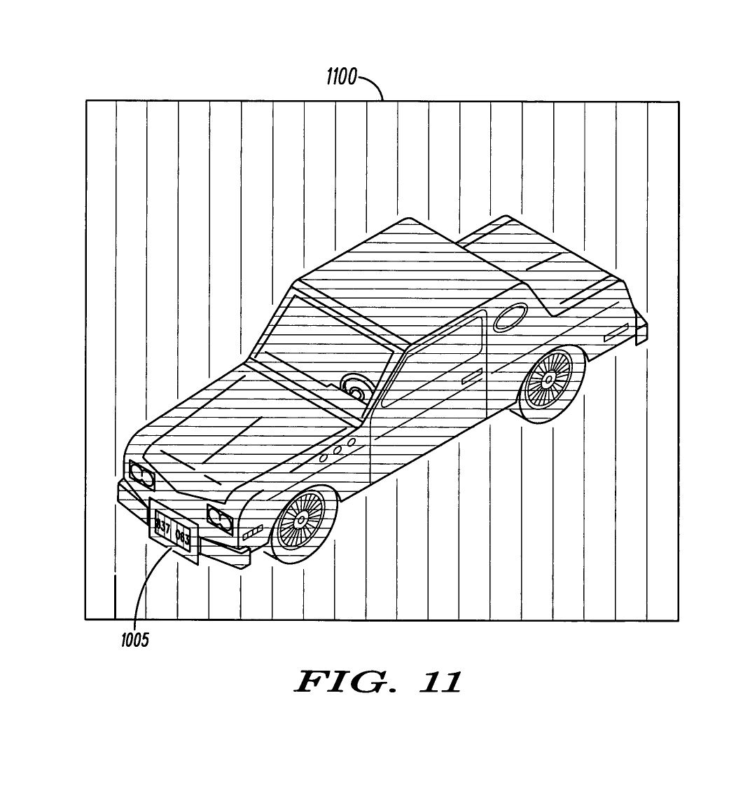

FIG. 11 illustrates a second image 1100 of the automobile that has been acquired with adjusted BLC values designed to optimize contrast of the ROI 1005 according to an embodiment of the invention. For example, the BLC value may be about −127. As shown, the entire image appears to be darker, and the contrast in bottom portion of the second image 1100 below the ROI 1005 appears to be worse than the contrast in the upper portion of the second image 1100. The ROI 1005, however, has much better contrast than it did in FIG. 10.

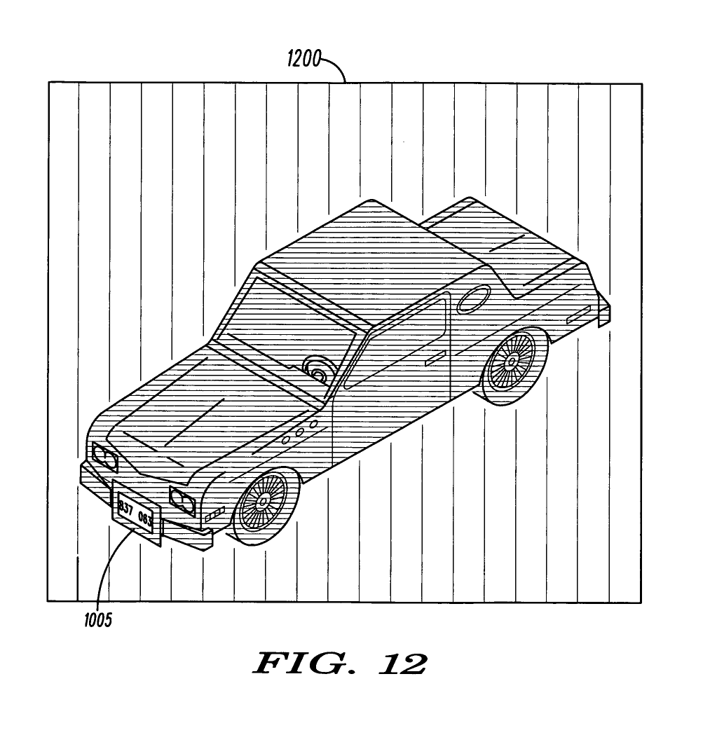

FIG. 12 illustrates a third image 1300 of the automobile that has been acquired with the adjusted BLC values designed to optimize the ROI contrast and the adjustment of the digital gain setting according to an embodiment of the invention. As shown, the contrast of the entire third image 1300 is much worse than it was in the first image 1000 or the second image 1100. The contrast of the ROI 1005, however, is far better than it was in either the first image 1000 or the second image 1100.

Therefore, as can be seen in a comparison of the first image 1000, the second image 1100, and the third image 1300, optimization of the ROI contrast may result in much worse overall image contrast in the second image 1100 and the third image 1300. Accordingly, whereas a system of the prior art would be directed to optimize the contrast of the entire image, a system according to an embodiment of the invention is instead directed solely to optimization of the ROI contrast, which results in better ROI contrast, but not necessarily better overall image contrast.

FIG. 13 illustrates a plot of the contrast measurements of the ROI of the images of FIGS. 10 and 11 according to an embodiment of the invention. As shown, at the default BLC value of about −10, the contrast level is about 2.50, as illustrated with a first plot location 1600. However, if the BLC is optimized to −127, the contrast level is maximized at a value of about 5.65, as shown with a second plot location 1700. Therefore, as shown, the contrast level is a function of the BLC value and may be optimized to achieve the maximum contrast.

Therefore, in accordance with embodiments discussed above, an image may be received from a video source for processing. The ROI may then be located within the image. For example, the image may be analyzed to detect an object of interest, such as a license plate in an image of an automobile or a road sign. If the object of interest is detected in the image, the ROI is obtained by, for example, bounding a box around the image of the license plate. Alternatively, the ROI may be determined based on prior knowledge of the image.

The contrast level of the ROI is then measured and sensor settings are adjusted to achieve an optimal contrast in the ROI. The contrast level may be measured by, e.g., calculating the sum of the absolute differences between pixels in the ROI to determine whether it meets the object recognition requirements. If it does not, the sensor black level calibration value and/or other sensor settings are adjusted to increase the image's ROI contrast until it reaches an optimal contrast range. For example, because the pixel values vary throughout the entire image, a superior ROI contrast level may be achieved by intentionally adjusting sensor settings to optimize the contrast in the ROI as opposed to attempting to optimize the contrast of the entire image as has been done previously in the art.

Once the contrast level has been optimized a new image is captured with the optimized sensor settings, and the new image may then be analyzed for the actual recognition process. Accordingly, as discussed above, by adjusting sensor settings to optimize the ROI contrast level, better ROI contrast may be achieved than would normally be possible if the contrast level of the entire image were adjusted. As a result, superior object recognition may be achieved.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

We claim:

1. A method, comprising:
locating a region of interest in an image;
measuring a contrast level of the region of interest; and
automatically adjusting, in response to the contrast level being below a predetermined threshold level, at least one sensor setting to increase the contrast level of the region of interest to at least the predetermined threshold level.

2. The method of claim 1, wherein the locating is based on pre-knowledge about where a location of the region on interest is likely to be in the image.

3. The method of claim 1, further comprising utilizing a default black level calibration value from a measurement of at least one of black rows and black columns of an image sensor used to acquire the image, and analyzing the image to detect an object of interest near the region of interest.

4. The method of claim 3, wherein the object of interest is a predetermined object having alphanumeric symbols.

5. The method of claim 4, wherein the object of interest is at least one of a license plate and a road sign.

6. The method of claim 3, further comprising obtaining the region of interest in the image in response to the object of interest being detected.

7. The method of claim 1, wherein the measuring of the contrast level comprises measuring a sum of absolute differences between adjacent pixels in the region of interest to determine if the sum meets the predetermined threshold level.

8. The method of claim 1, wherein the at least one sensor setting is at least one of an offset correction voltage, an analog gain setting, and a digital gain setting.

9. The method of claim 1, further comprising capturing an image using the at least one adjusted sensor setting.

10. The method of claim 9, further comprising performing an image recognition process on the image captured using the at least one adjusted sensor setting.

11. A system, comprising:
an image sensor having a captured image output; and
a processing device operably coupled to the captured image output and being configured and arranged to:
locate a region of interest in the captured image,
measure a contrast level of the region of interest, and
automatically adjust, in response to the contrast level being below a predetermined threshold level, at least one sensor setting of the image sensor to increase the contrast level of the region of interest to at least the predetermined threshold level.

12. The system of claim 11, the processing device being adapted to locate the region of interest based on pre-knowledge about where a location of the region of interest is likely to be in the captured image.

13. The system of claim 11, the processing device being adapted to utilize a default black level calibration value from a measurement of at least one of black rows and black columns of the image sensor used to acquire the captured image, and analyze the captured image to detect an object of interest near the region of interest.

14. The system of claim 13, the processing device being adapted to obtain the region of interest of the captured image in response to the object of interest being detected.

15. The system of claim 13, the processing device being adapted to measure the contrast level by measuring a sum of absolute differences between adjacent pixels in the region of interest to determine if the sum meets the predetermined threshold level.

16. The system of claim 11, the at least one sensor setting being at least one of an offset correction voltage, an analog gain setting, and a digital gain setting.

17. An apparatus, comprising:
an input to provide an image;
a processing device to:
locate a region of interest in the image,
measure a contrast level of the region of interest, and
automatically adjust, in response to the contrast level being below a predetermined threshold level, at least one sensor setting of an image sensor to increase the contrast level of the region of interest to at least the predetermined threshold level.

18. The apparatus of claim 17, the processing device being adapted to locate the region of interest based on pre-knowledge about where a location of the region of interest is likely to be in the image.

19. The apparatus of claim 17, the processing device being adapted to utilize a default black level calibration value from a measurement of at least one of black rows and black columns of an image sensor used to acquire the image, and analyze the image to detect an object of interest.

20. The apparatus of claim 17, the at least one sensor setting being at least one of an offset correction voltage, an analog gain setting, and a digital gain setting.
